(19) United States
(12) Patent Application Publication
(10) Pub. No.: US 2008/0212882 A1
(43) Pub. Date: Sep. 4, 2008

(54) Pattern Encoded Dictionaries

(75) Inventors: Hans Christian Meyer, Oslo (NO); Mats Stefan Carlin, Gjettum (NO); Knut Tharald Fosseide, Trollasen (NO)

Correspondence Address: VOLPE AND KOENIG, P.C., UNITED PLAZA, SUITE 1600, 30 SOUTH 17TH STREET, PHILADELPHIA, PA, 19103, US

(73) Assignee: Lumex AS, Oslo (NO)

(21) Appl. No.: 11/916,960

(22) PCT Filed: Jun. 14, 2006
(86) PCT No.: PCT/NO06/00227

§ 371 Date: Mar. 6, 2008

(30) Foreign Application Priority Data
Jun. 16, 2005 (NO) 20052966

(51) Int. Cl. G06K 9/72

(52) U.S. Cl. 382/229

(57) ABSTRACT

The present invention is related to a method and system providing a pattern-classifier encoded dictionary for use in language processing systems implemented in computer systems. The pattern encoded dictionary according to the present invention may be utilized in Optical Character Recognition systems or (OCR) or Automatic Speech Recognition systems (ASR) to retrieve reliably identified words used in an adaptive manner or as a tool to configure said OCR or ASR system.

### FIELD OF INVENTION

The present invention is related to a method and system for providing a pattern encoded dictionary for use in language processing in computer systems, such as Optical Character Recognition (OCR) systems or Automatic Speech Recognition systems (ASR), and especially to a pattern encoded dictionary using at least one pattern-classifier related to patterns of characters or phonemes representing language elements retrieved from a specific language dictionary.

### BACKGROUND

The present state-of-the art text recognition systems, often denoted as Optical Character Recognition Systems, are typically based on template matching with known fixed templates, by structural matching or by recognizing the characters based on a set of fixed set of recognition rules using a set of computed features extracted from the shapes of characters. Each character will be assigned a score or an a priori calculated probability for each character class or set. A dictionary is used to check that each chain of proposed characters can form words, picking the most probable word.

The state-of-the art text recognition systems usually fails when they encounter moderate to heavily degraded text images. Such degrading of text images may be a result of photocopying an original document, typewritten documents which may be encountered when scanning older archive material, newspapers which usually have poor print and paper quality effecting the quality of the text images, faxes which usually has poor resolution in the transmission channel and printing device, etc. These and similar problems are described in the book by Stephen Rice et al, “Optical Character recognition—An illustrated Guide to the Frontier”, Kluwer Academic Publishers 1999.

The current text recognition systems do only to a limited extent adapt to specific font or deformation of the text without a guided learning phase requiring human interaction in the process, which slows down the process considerably. Electronic document handling, archive systems, electronic storage of printed material etc. requires scanning of unlimited number of pages which makes it impossible to use human interaction to succeed with such tasks.

In this respect automatic speech recognition systems face problems that are very similar to the problems encountered with deformed images in OCR processing. The starting point of recognizing either OCR input or ASR input is to be able to recognize some words and/or characters as reliably recognized. Based on such reliably identified items, the OCR or ASR process may continue in an adaptive fashion or as a configurable system. Whenever there is a deformation in the OCR input, or the ASR input is deformed for example due to different voice patterns of different persons, the ability to recognize some characters or words as reliably is diminished. However, according to the present invention some characters, words may be reliably identified by providing a pattern encoded dictionary based on at least one identifiable pattern-classifier related to patterns found in images comprising text, even in images comprising heavily deformed text, in OCR systems, or in digital images of phonemes in ASR systems.'

PCT patent application WO 2005/050473 A2 disclose a method for semantic clustering of text segments in a language processing system based on their semantic meaning.

The clusters refers to one or several semantic topics and are used for the training of language models. The semantic clustering of the disclosure is based on a text emission model and cluster transmission model providing a probability estimate that a text is concerned with a specific semantic topic.

### SUMMARY

The aim of the present invention is to cluster words based on the physical, geometrical and structural similarity of language elements such as letters, syllables or phonemes when they are represented in a computer system. This is achieved by applying a pattern-classifier to cluster the words based on their similarity. By clustering all words with similar patterns in a dictionary, it is possible to perform a look-up in the pattern-classifier encoded dictionary based on a specific pattern and the dictionary will output a list of all words in the corresponding cluster. The semantic meaning or topic is irrelevant to the pattern-classifier of the present invention.

According to an aspect of the present invention, words form repeating patterns due to the repeating nature of letters constituting words. In prior art, this phenomena is used for example in crypto analysis. According to the present invention, at least one pattern-classifier related to such repeating aspects of letters constituting words provided in a specific language to be processed in an OCR program or in an ASR system, is used to encode a pattern dictionary relating said at least one pattern-classifier with said words thereby enabling a recognition of words of text input in said OCR or ASR system by identifying said at least one pattern-classifier from any OCR input (digital image of scanned or digitally photographed document input) or any input representing patterns of speech in digital form (digitized microphone input, file, etc.), and use said pattern encoded dictionary to recognize said OCR or ASR input.

According to another aspect of the present invention, several different pattern encoded dictionaries encoding different aspects of said pattern-classifiers, or that are providing encoding of different pattern-classifiers may be used on the same OCR or ASR input to increase the amount of recognized text from said input.

### BRIEF DESCRIPTION OF THE DRAWINGS

FIG. 1 illustrates schematically an example of embodiment of the present invention.

FIG. 2 illustrates use of staff-lines according to an example of embodiment of the present invention.

FIG. 3 is another example of encoding according to an example of embodiment of the present invention.

FIG. 4 is another example of encoding according to an example of embodiment of the present invention.

FIG. 5 is another example of encoding according to an example of embodiment of the present invention.

FIG. 6 is an example of non-periodic sound (the letter [f] in the word [first]) according to an example of embodiment of the present invention.

FIG. 7 is an example of periodic sound (the letter [m] in the word [met]) according to an example of embodiment of the present invention.

FIG. 8 is an example of transient plosive sound (the letter [t] in the words [first met]) according to an example of embodiment of the present invention.

FIG. 9 is a schematic flow diagram of a preferred embodiment of the present invention.

### DETAILED DESCRIPTION OF THE PREFERRED EMBODIMENTS

A detailed description of a preferred embodiment of the present invention will be provided in the following sections by first describing some examples of pattern-classifiers related to patterns found in the OCR domain and the ASR domain, respectively, followed by a description of an example of a preferred method and system utilizing said method providing a pattern encoded dictionary.

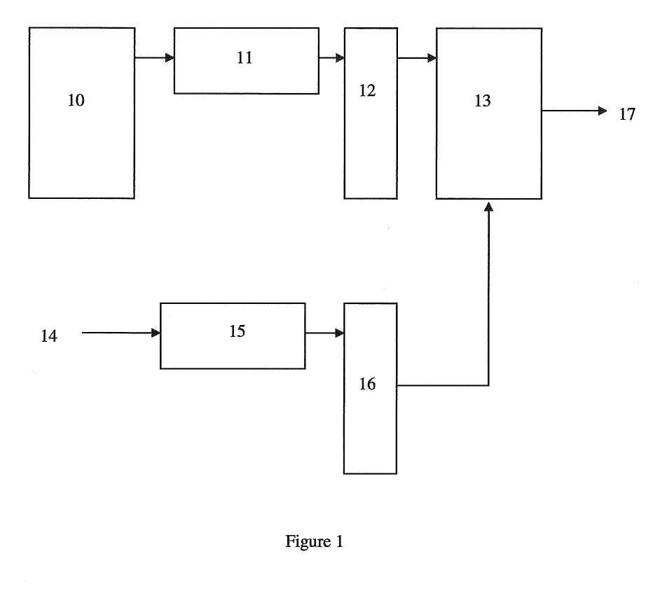

FIG. 1 illustrates an example of embodiment of the present invention. An existing dictionary 10 for a specific language, for example English, used in OCR or ASR, is analyzed in section 11 to provide at least one pattern-classifier related to patterns associated with said words comprised in said dictionary 10. The at least one pattern-classifier identified in 11 is then used to create a relationship 12 between the patterns and words analyzed in 11 to provide said patterns relating words from dictionary 10 in a list 13. Binary bitmap input 14 from an OCR input (scanner, camera etc.) or an ASR input (digital microphone output, computer file etc.) is then analyzed in 15 which is a similar analyzing element as 11 providing patterns based on said at least one pattern-classifier. The patterns 16 are then used to address the list 13 providing an output of words 17 related to said pattern. If the pattern identifies uniquely a single word, this single word is output from the list 13. If the pattern is related to a plurality of words, the plurality of words is output from the list 13. The output 17 from the list 13 is then communicated to for example an adaptive section in an OCR or ASR system, or is used to configure (manually or automatically) an OCR or ASR system for further recognition of characters and/or words from input 14.

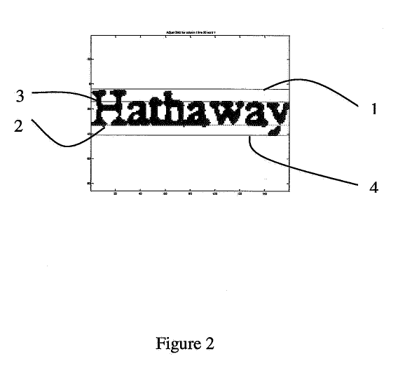

As an example of pattern-classifiers related to patterns in images in OCR systems, FIG. 2 illustrates an example of use of staff-lines. With reference to FIG. 2, a text line is characterized by its staff-lines called descender line 4, ascender line 1, baseline 2, and x-height line 3. According to an aspect of the present invention, such staff-lines may be used to encode patterns related to how characters are positioned relative to such staff-lines.

According to an example of embodiment of the present invention, letters extending above the x-height line 3, as shown in FIG. 2, are encoded by the letter O (over), letters extending below the baseline 2 are encoded by the letter U (under) and the remaining letters are encoded by the letter M (mid). For example, the word “funny” is now encoded as OMMMU and “instruments” as OMMOMMMMMOM, a type of encoding that limits the number of possible letter combinations. According to an example of embodiment of the present invention, an English dictionary containing about 125 000 words are encoded, as depicted in FIG. 1, providing a pattern encoded dictionary according to the present invention.

According to another example of embodiment of the present invention, the encoding to words are extended to characters that are not character segmented, where each fragment of the character is encoded in a similar manner as described above. As an example, the fragmented word ‘funny’ would be encoded as OMMMMMMUM where the ‘u’ and ‘n’ are coded as MM due to the dual stems and the ‘y’ is coded as UM. By this approach a pattern-classifier encoded dictionary can be used as a tool to solve segmentation problems within text recognition if unique patterns can be identified.

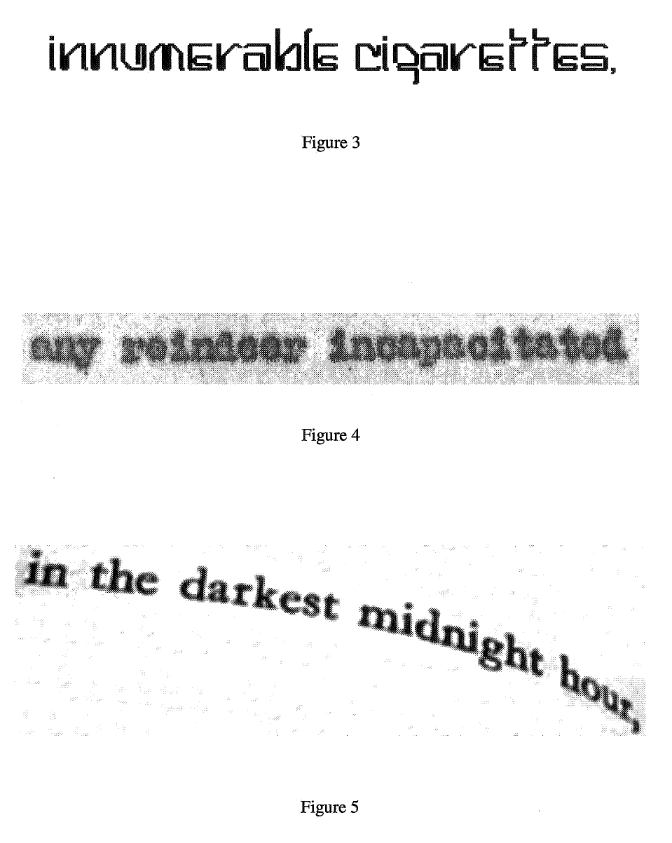

FIG. 3 illustrates an example of an unusual font (Harpoon) with a very short phrase that can be recognized solely using a pattern encoded dictionary, according to the present invention. Even though humans easily read this text, no commercial OCR software such as Scansofts OmniPage or ABBYYs FineReader is capable of recognizing this example of text since there exist no templates of the Harpoon font in any of the programs and the character structure of this font is slightly different from the common character structure found in many other fonts.

An example of pattern that may be used is the ascender/descender pattern of the two words, which are OMMMMMMMOOM MOUMMMOOMM. In said example of an English dictionary comprising about 125 000 words, ‘cigarettes’ is the only word in this dictionary that has an ascender/descender pattern of MOUMMMOOMM. Without any other information than the segmentation of the characters and the ascender/descender pattern, the method according to the present invention is able to recognize the word as ‘cigarettes’ using this specific dictionary and said ascender/descender encoding.

The ascender/descender pattern for the word ‘innumerable’ in FIG. 3 provides 14 possible words from said English dictionary (denumerable, foreseeable, hermeneutic, increasable, inenarrable, inexcusable, innumerable, irrecusable, irremovable, irrevocable, leucocratic, traversable, treasonable, and treasurable) having the same ascender/descender pattern. Since the method according to the present invention recognized the single word “cigarettes”, the eight characters ‘acegirst’ encountered in the word “cigarettes” may be used to provide either templates or pattern-classifier-based recognition of the word ‘innumerable’. The part-wise recognized ascender/descender pattern for ‘innumerable’ becomes iMMMMeraOOe, and there is only one alternative in the dictionary, ‘innumerable’. Using only two words and their ascender/descender pattern, the method according to the present invention is able to recognize the thirteen characters ‘abcegilmnrstu’ of such an unknown font.

FIG. 4 is an example of low quality archive material with a typewriter font of a very short phrase that can be partly recognized using a pattern encoded dictionary according to the present invention. Again no ordinary OCR is even close to recognizing the example because of the noise level. The text is monospace and character segmentation is therefore trivial.

According to an aspect of the present invention, ascender/descender pattern of the three words in FIG. 4, which are MMU MMOMOMMM OMMMUMMOOMOMO, may be used in a pattern encoded dictionary. A quick check in such a pattern encoded dictionary, such as the English dictionary used above, provide ‘incapacitated’ as a unique pattern and can be recognized directly, while ‘any’ has 52 alternative words with the same ascender/descender pattern and ‘reindeer’ has 60 alternative words with the same ascender/descender pattern. To recognize the two first words ‘any reindeer’, an example of embodiment of the present invention narrows down the alternatives further. Both the character ‘i’ and the character ‘d’ have quite distinct outer contours (shapes) in the word ‘incapacitated’ and robust recognition rules for these two characters based on the outer contours may be used. In an example of embodiment, the pattern is reduced to MMiMdMMM, and this pattern is unique for ‘reindeer’.

According to another aspect of the present invention, more elaborate pattern encoding may be used for recognition purpose than the ascender/descender encoding used in the previous examples. An example of embodiment of the present invention is using encoding of bows and stems as illustrated in table 1 below.

TABLE 1
Example of bow and stem encoding

| Encoding | Typical | |
|---|---|---|
| symbol | characters | Description |
| A | ‘d’ | Single right position ascender stem |
| B | ‘filt’ | Single mid position ascender stem |
| C | ‘bhk’ | Single left position ascender stem |
| D | ‘qg’ | Single right descender stem |
| E | ‘py’ | Single left descender stem |
| F | ‘aceos’ | Left convex bow x-height character |
| G | ‘r’ | Single stem x-height character |
| H | ‘mnu’ | Multiple stem x-height character |

Applying the bow/stem encoding provided in table 1, the pattern FHE GFBHAFFG BHFFEFFBBFBFA will represent the sentence ‘any reindeer incapacitated’ illustrated in FIG. 4. Using an English dictionary comprising 125 000 words encoded with the patterns from table 1, the word ‘incapacitated’ is a unique pattern, the word ‘reindeer’ is also a unique pattern, while there are four alternative words (amp, any, cup, sup) in the dictionary with the same pattern as the word ‘any’.

According to yet another aspect of the present invention, topological properties of a character, expressed for example in mathematical terms as the number of elements and holes that constitute the character, may be used in providing a pattern encoded dictionary. An example is provided in table 2 below. In the example in table 2, we have used additional information about the position of holes within the character.

TABLE 2
Example of topological encoding of characters in dictionary words

| Encoding | | |
|---|---|---|
| symbol | Typical characters | Description |
| C | ‘cfhklmnrstuvwxyz’ | Single shape element with no holes |
| D | ‘bdopq’ | Single shape element with one central |
| | | hole |
| E | ‘ae’ | Single shape element with one offset |
| | | hole |
| B | ‘g’ | Single shape element with two holes |
| I | ‘ijü’ | Multiple shape elements with no holes |
| A | ‘äö’ | Multiple shape elements with holes |

The text in FIG. 5 is acquired by a digital camera and geometric distortion makes it difficult to recognize the text since the size and skew of the characters change along the text line. Topological properties can however easily be computed for each individual character, as known to a person skilled in the art.

Applying the topological pattern encoding from table 2 and encoding the text in FIG. 5, provides the resulting pattern IC CCE DECCECC CIDCIBCC CDCC. The word ‘midnight’ has a unique pattern and is directly recognized in a dictionary comprising 125 000 words, encoded with this example of pattern, while the word ‘darkest’ has 72 alternatives and ‘hour’ has 152 alternatives with the same pattern encoding. The word ‘in’ has only six alternatives (if, in, is, it, iv, ix), all starting with the character ‘i’, the last two being roman numerals.

Combining the topological properties from table 2 with the ascender/descender encoding described above, a unique pattern for the word ‘darkest’ is provided among the 125 000 words in said dictionary.

Automatic speech recognition systems (ASR) face the same type of problems as found in OCR in the sense that some patterns representing elements (letters, words etc.) must be recognized reliable to be able to provide an adaptation or configuration of the ASR system. According to an aspect of the present invention, pattern encoding of sound may be based on phoneme types. For example, speech may be divided in vowels [sound patterns related to the letters aeiouy], nasals [nm], laterals [l], thrills [r], fricatives [fsvz] and plosives [ptkbdg] with or without distinguishing between voiced and unvoiced sounds.

For example, the word ‘instruments’ is then encoded as VNFTVNVNPF where V represents vowels, N nasals, F fricatives, T thrills and P plosives. This is only an example of encoding, and different sound combinations can be used. Some sounds will represent several characters in speech and other classifications of sounds can be used as well, according to the present invention.

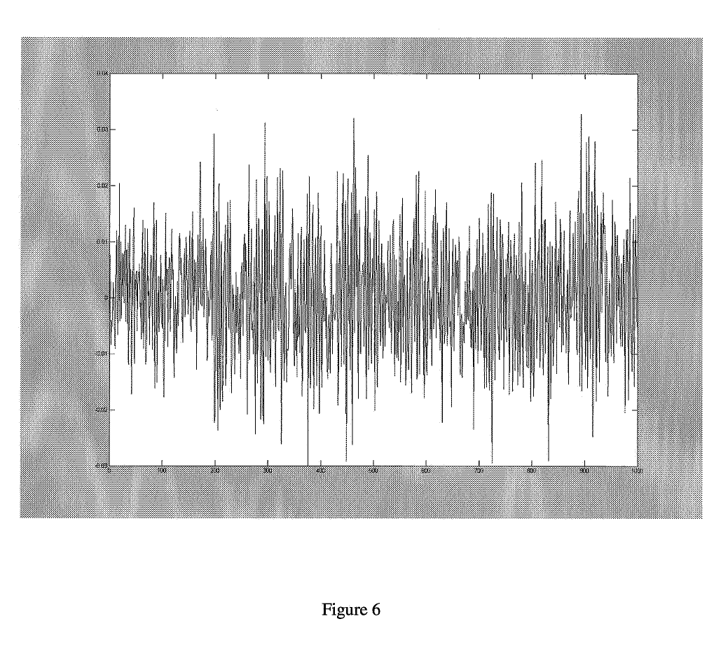

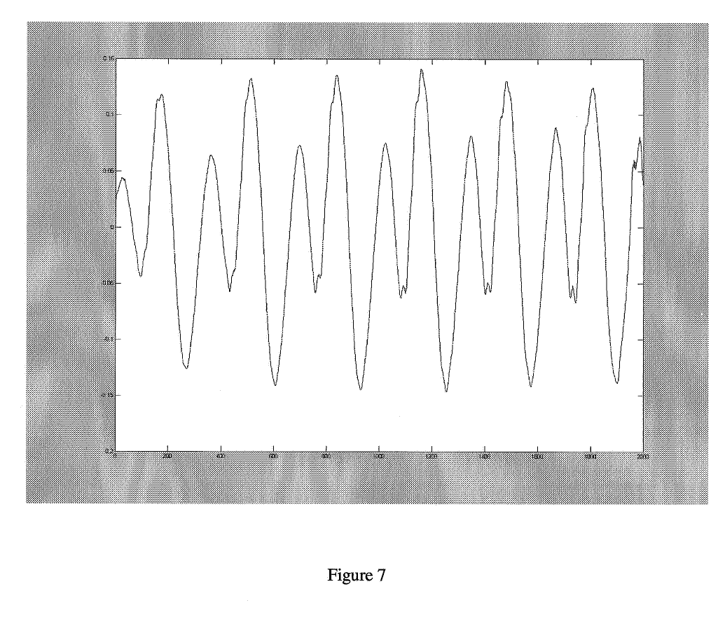

According to yet another aspect of the present invention, sound may also be encoded using an encoding scheme based on patterns found in images of sound patterns, for example the amplitude variation of sound output from a microphone with respect to time. FIG. 6 illustrates such a relationship for the letter f in the word first. This type of pattern is characterized by stationary non-periodic sound comprising signals with random behaviour and large degree of high-frequency content in the temporal sound signal. Stationary non-periodic sounds are easily distinguished from the other sound types, for example by Fourier transformation as known to a person skilled in the art.

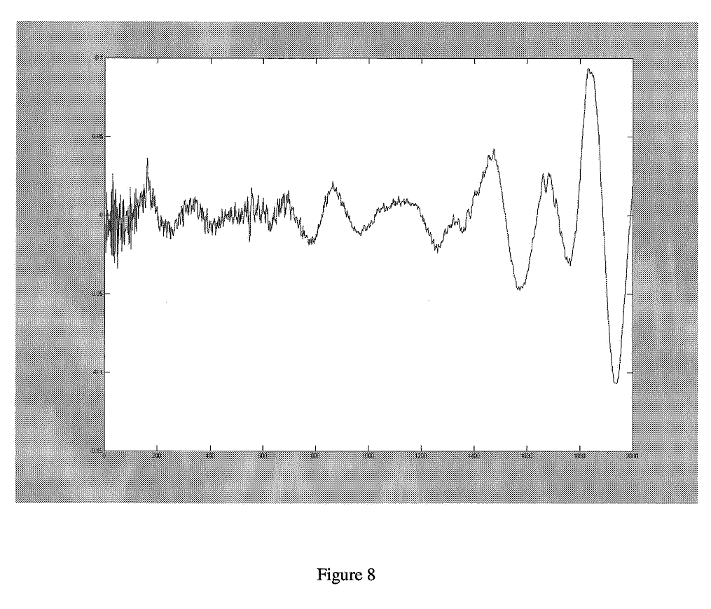

According to another aspect of the present invention, all vocoids sounds and some voiced and thrilled consonants are quasi-stationary periodic sounds characterized by a repeating sound pattern with a small number of frequencies called formant frequencies. It is the vocal chord that decides the basic frequency and the position of the moveable elements of the vocal tract that decides the formant frequencies. These voiced sounds are often further classified based on the number of formants and relative frequencies of the formants in automatic speech recognition systems. A large source for errors is the large variation from speaker to speaker. It is however easy to distinguish quasi-stationary periodic sounds from other sound types, for example by Fourier transform of the sound signal as known to a person skilled in the art. FIG. 7 illustrates an example of periodic sound for the letter m in the word met.

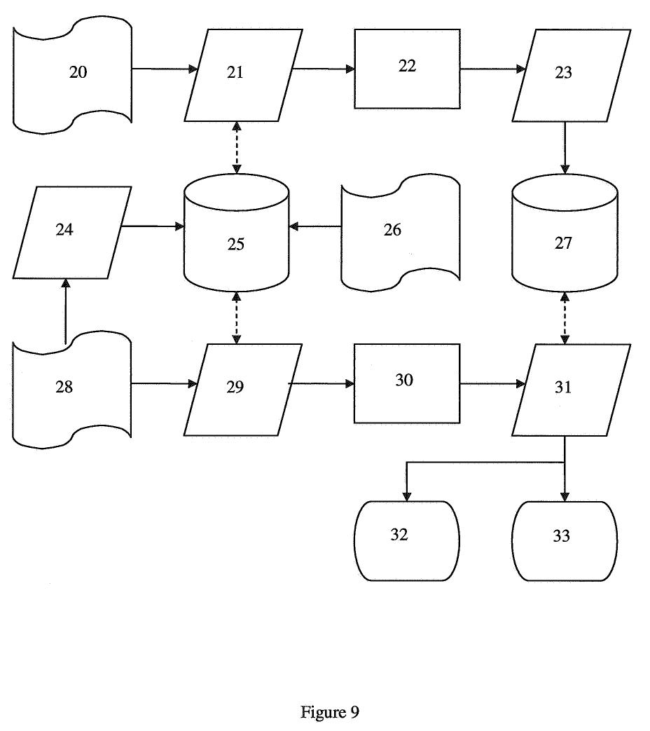

According to yet another aspect of the present invention, plosive sounds are characterised by their non-stationary transient sound signal as the vocal tract is closed and opened again during the speech. The plosives may contain a transient closing phase, a quelling phase (muted or voiced) and transient opening phase. Even though each of the plosives has a distinctly different sound signal, they are easily distinguished from other sound types, for example by Fourier transform as known to a person skilled in the art. FIG. 8 illustrates an example of transient plosive sound for the letter t in the word met.

According to an example of embodiment of the present invention, an encoding scheme providing an N for the stationary non-periodic sounds [fsvz], P for the periodic sounds [aeiouynmlr] and T for the transient sounds [ptkbdg] may be used to encode a pattern encoded dictionary, for example for the English language. In an example of dictionary comprising 125 000 words, the word ‘instruments’ is then encoded as PPNTPPPPPTN. There are only 4 out of 125 000 words in said dictionary that matches this pronunciation-based encoding pattern. These 4 words are instalments, instruments, masterminds and restaurants. By independently recognizing for example the thrill (‘r’) in the word ‘instruments’, a unique pattern is provided. According to the example of embodiment of the present invention as depicted in FIG. 1, en English dictionary 10 may be analyzed in section 11 to provide such patterns 12 that relates sounds representing words and letters provided in the list 13. Whenever a sound input 14 is analyzed in section 15, the pattern 16 may be used to find the related words and letters from the list 13, and the output 17 may be used to provide an adaptation or a manual or automatic configuration of an ASR system.

FIG. 9 depicts a flow diagram illustrating a preferred embodiment of the present invention. The starting point for providing a pattern encoded dictionary is to analyze an existing dictionary comprising a specific language, for example English. In FIG. 9, the dictionary 20 is analyzed in section 21. The coding system to be used may be stored in the storage location 25, which may comprise the encoding scheme as illustrated in Table 1 and Table 2 above, for use in an OCR system, or the storage location 25 may comprise schemes for encoding phonemes as described above when used in an ASR system. According to an aspect of the present invention, the storage location 25 may comprise several encoding schemes, for example both the schemes provided by table 1 and 2.

In addition to the specific encoding schemes to be used in the analyzing section 11, the storage location 25 may comprise encoding schemes incorporating results from statistical pattern-classifier analysis provided in section 24 and/or a priori knowledge about a specific language contained in section 26. In an example of embodiment, the statistical analysis section 24 receives text image or speech signals from section 28, and is analysing the input to estimate which set of pattern-classifiers are best represented in the input, providing an ability for the analysing section 21 to provide pattern-classifier patterns 22 that are significant in the actual text image or speech signal. In this manner, the pattern encoded dictionary may be provided as a “best fit” for the actual input 28. When said pattern-classifier patterns 22 are analyzed, the output is communicated to the clustering section 23, providing dictionary listings relating said patterns with words from the dictionary 20 in the storage location 27. A text image input or speech signal 28 is analyzed in section 29 to provide pattern-classifier patterns 30. The section 29 receives the same encoding schemes used in the section 21 from the storage location 25. The output from section 30 is used to perform a dictionary lookup process in 31 by addressing the list provided in section 27 with the pattern-classifier pattern from section 30. The output from the dictionary lookup section 31 results in either a unique word or sound identification 32, or a list of candidates 33. The output 32 and 33 is used for adaptation or configuration of an OCR or ASR system.

According to an aspect of the present invention, the list of candidates 33 should be a minimum. The ideal situation is only to have unique identifications 32. However, according to an example of embodiment of the present invention, the number of candidates 33 may be reduced by repeating, for example the steps of the preferred embodiment as depicted in FIG. 9. However, the selection of pattern-classifier to be used should be different form the previously used. In this manner, more reliably identified words may be linked to the pattern-classifier in use. According to yet another example of embodiment of the present invention, a plurality of pattern classifiers may be used in creating the pattern dictionary. Any combination of pattern-classifiers may also be used. For example, at least a first pattern-classifier and at least a second pattern-classifier may used in combination as a Boolean expression, or any Boolean expression or sequence of Boolean expressions may be used in pattern-classifiers according to the present invention.

1. Method for providing a pattern-classifier encoded dictionary for use in language processing in computer systems, such as Optical Character Recognition (OCR) systems or Automatic Speech Recognition (ASR) systems, comprising the steps of:
a) selecting at least one pattern-classifier related to language elements of a specific language based on the physical, geometrical or structural similarity of the language elements when used in a computer system for language processing,
b) retrieving words from a dictionary representing words of a specific language and then use at least one pattern-classifier to cluster the words into different clusters according to the at least one pattern-classifier,
c) creating a relationship between each of the word clusters and the at least one pattern-classifier in a manner of a dictionary, such that when at least one pattern-classifier of the used type for the clustering of words is presented to the dictionary, a list of the words in the corresponding cluster is outputted from the dictionary for use in the language processing system.

2. Method according to claim 1, wherein said step a), b) and c) is repeated to minimize the number of words in each clustering of said words in said step c) by utilizing another at least one pattern-classifier in step a).

3. Method according to claim 1, wherein said step a) comprises selecting a plurality of pattern-classifiers.

4. Method according to claim 1, wherein said step a) comprises selecting a combination of at least two pattern-classifiers.

5. Method according to claim 1, wherein said language elements are letters, and wherein said at least one pattern-classifier is the horisontal position of ascenders or descenders to staff-lines comprising said letters.

6. Method according claim 1, wherein said instances representing language elements are letters, and wherein said at least one pattern-classifier is bow and stem to said letters.

7. Method according claim 1, wherein said instances representing language elements are letters, and wherein said at least one pattern-classifier is number of holes and elements to said letters.

8. Method according to claim 1, wherein instances representing language elements are sound elements, and said at least one pattern-classifier is phoneme type related to said sound elements.

9. Method according to claim 8, wherein said phoneme type are vowels, nasals, laterals, thrills, fricatives and plosives.

10. Method according to claim 8, wherein said sound elements are voiced or unvoiced sounds.

11. System for providing a pattern-classifier encoded dictionary for use in language processing in computer systems, such as Optical Character Recognition (OCR) systems or Automatic Speech Recognition (ASR) systems, comprising:
d) programmodule comprising instructions selecting at least one pattern-classifier related to language elements of a specific language based on the physical, geometrical or structural similarity of the language elements when used in a computer system for language processing,
e) programmodule comprising instructions retrieving words from a dictionary representing words of a specific language and then use at least one pattern-classifier to cluster the words into different clusters according to the at least one pattern-classifier,
f) programmodule comprising instructions creating a relationship between each of the word clusters and the at least one pattern-classifier in a manner of a dictionary, such that when at least one pattern-classifier of the used type for the clustering of words is presented to the dictionary, a list of the words in the corresponding cluster is outputted from the dictionary for use in the language processing system.

12. System according to claim 11, wherein said step d), e) and f) is repeated to minimize the number of words in each of said linking of words in said list.

13. System according to claim 11, wherein said step d) comprises specifying a plurality of pattern-classifiers.

14. System according to claim 11, wherein said step d) comprises specifying a combination of at least two pattern-classifiers.

15. System according to claim 1, wherein said language elements are letters, and wherein said at least one pattern-classifier is the horisontal position of ascenders or descenders to staff-lines comprising said letters.

16. System according claim 11, wherein said instances representing language elements are letters, and wherein said at least one pattern-classifier is bow and stem to said letters.

17. System according claim 11, wherein said instances representing language elements are letters, and wherein said at least one pattern-classifier is number of holes and elements to said letters.

18. System according to claim 11, wherein instances representing language elements are sound elements, and said at least one pattern-classifier is phoneme type related to said sound elements.

19. System according to claim 18, wherein said phoneme type are vowels, nasals, laterals, thrills, fricatives and plosives.

20. Method according to claim 18, wherein said sound elements are voiced or unvoiced sounds.
